(19) United States
(12) Patent Application Publication
(10) Pub. No.: US 2002/0159591 A1
(43) Pub. Date: Oct. 31, 2002

(54) The copy protection of digital audio compact discs

(76) Inventors: Richard AA Heylen, Leeds (GB); Roger Edward, Reading (GB)

Correspondence Address: PATENT DEPARTMENT, MACROVISION CORPORATION, 2830 DE LA CRUZ BLVD., SANTA CLARA, CA, 95050, US

(21) Appl. No.: 09/958,445

(22) PCT Filed: Feb. 14, 2001
(86) PCT No.: PCT/GB01/00606

(30) Foreign Application Priority Data
Feb. 15, 2000 (GB) 0003530.3

(51) Int. Cl. H04N 7/167

(52) U.S. Cl. 380/201

(57) ABSTRACT

The ability of a data reader to access, extract, or otherwise read the data on a CD-DA provides a problem for the music industry. A user can use his CD-ROM drive to read the data from an audio disc into a computer file, and then that data can be copied. Therefore, errors are deliberately introduced into the encoded data, these errors being of a type which are generally transparent to an audio player but which will interfere with the extraction or reading of the audio data by a data reader. The data on a CD is encoded into frames by EFM (eight to fourteen modulation), and each frame includes 24 bytes of audio data. There are 8 sub-code bits contained in every frame which enable 8 different subchannels, P to W, to be formed. The P- and Q-subchannels incorporate timing and navigation data for the tracks on the disc, and generally are the only subchannels utilised on an audio disc. It is the timing and/or navigation data in the P- and Q-subchannels which is rendered incorrect or inaccurate to provide the copy protection.

The present invention relates to a method of copy protecting a digital audio compact disc, and to a copy protected digital audio compact disc.

Digital audio compact discs (CD-DA) which carry music or other audio can be played or read by more sophisticated apparatus, such as CD-ROM drives. This means, for example, that the data on a CD-DA acquired by a user may be read into a PC by way of its ROM drive and thus copied onto another disc or other recording medium. The increasing availability of recorders able to write to CDs is therefore an enormous threat to the music industry.

In an earlier proposed method, a digital audio compact disc is copy protected by rendering control data encoded onto the disc incorrect and/or inaccurate. The incorrect data encoded onto the CD is either inaccessible to, or not generally used by, a CD-DA player. Therefore, a legitimate audio CD bought by a user can be played normally on a compact disc music player. However, the incorrect data renders the CD unplayable by a CD-ROM drive.

However, as the audio compact disc is rendered unplayable on a CD-ROM drive, the user is also prevented from using the CD-ROM drive legitimately simply to play the music or other audio on the disc.

It clearly would be advantageous to provide a method of copy protection for a digital audio compact disc which, whilst preventing the production of usable copy discs, would not prevent or degrade, the playing of legitimate audio discs on all players having the functionality to play audio discs.

According to a first aspect of the present invention there is provided a method of copy protecting a digital audio compact disc, wherein control data is encoded on the compact disc, the copy protection method comprising the step of rendering selected control data incorrect and/or inaccurate whereby the incorrect and/or inaccurate control data interferes with the reading of audio data from the digital audio compact disc.

Generally, the incorrect and/or inaccurate control data is arranged such that it cannot be corrected by the error correction arrangements of available data readers. The error correction arrangements of some data readers may ostensibly provide “corrections”, but will thereby incorrectly render any data extracted. Other data readers will be prevented from extracting the data because of their inability to correct the errors.

With an embodiment of the invention, the incorrect data encoded onto the CD would either be ignored or would otherwise not generally have an effect on the playing of the audio data on the disc. Therefore, a legitimate audio CD bought by a user can be played normally on any player able to play audio data. However, where a copy of the copy protected CD is to be made by reading the audio data, extraction of the audio data is prevented, or playing of any copy CD made is prevented or the sound it is able to produce is degraded.

In this specification the term “audio player” is used to refer to players and drives arranged or controlled to play the audio data on a digital audio compact disc. Such players will include, therefore, commercially available CD music players which function solely to play the music or other audio on the CD. It is required that the incorrect data encoded onto the CD does not generally impinge on, or effect the normal operation of, such an “audio player”.

In this specification, the term “data reader” is used to refer to all players and drives arranged or controlled to read the data on the disc, for example, by extracting or otherwise accessing the data on the disc. Such players will include, therefore, CD-ROM drives when configured or controlled to read or extract data from the disc. In this respect, it is required to enable a CD-ROM drive, for example, to play a legitimate CD-DA, but to prevent such a CD-ROM drive from being used to make a usable copy of the disc.

In an embodiment of a method of the present invention, the data encoded on the compact disc which has been rendered incorrect is navigation and/or timing data.

Preferably, in an embodiment of a method of the present invention, the data encoded on the compact disc which has been rendered incorrect is P-subchannel or Q-subchannel data.

In a preferred embodiment, navigation and/or timing data from the P-subchannel and/or from the Q-subchannel is modified.

In an embodiment, P-subchannel data, identifying the start and length of audio tracks on the disc, is modified.

Additionally and/or alternatively, Q-subchannel data defining the Ttime of audio tracks on the disc is modified.

Additionally and/or alternatively, Q-subchannel data defining the Atime across the disc is modified.

For example, the Atime is modified to change the profile of the Atime across the disc. The profile of the modified Atime may be stepped, discontinuous, modulated or otherwise altered.

Additionally and or alternatively, the Ttime of individual audio tracks is modified to change the profile of the Ttime along the corresponding audio track. The profile of the modified Ttime may be stepped, discontinuous, modulated or otherwise altered.

Methods of the present invention may additionally and/or alternatively have other control data which is incorrect and/or inaccurate.

It will be apparent that the manner in which the navigation and/or timing data is modified, and the modifications which are made to the navigation and/or timing data, may be chosen as required in order to meet the objectives of providing for copy protection of an audio disc without preventing or degrading normal play of a legitimate audio disc. In this latter respect, it is generally necessary to make no modifications to navigation and/or timing data identifying the start or end of individual audio tracks, or identifying index marks on the disc.

Data readers may be enabled to serially extract audio data (digital audio extraction) in a manner which leads them to ignore incorrect data. For example, a data reader may continue data extraction, even where frames of data clearly have incorrect timing information, if a frame or sector further along the track can be identified. In such a case, the operation of the data reader is similar to that of an audio player.

In an extension of a method of the invention, for use where frames of control data are read into a frame content buffer of a data reader, the number of data frames in a sector with incorrect control data is arranged to exceed the number of data frames which can be held in the frame content buffer.

With the extension of the method of the invention, the data reader is not able to locate within the frame content buffer a frame giving data which is further along a time profile, for example, than the data from the frames being processed. Therefore, the data reader is not able to navigate along the time profile, or to a known location, and has to deal with the inaccurate data. This can stop the data extraction and/or cause the extraction of data which will lead to degradation of audio.

Preferably, the control data encoded on the compact disc is altered prior to mastering of the disc. Specifically, the encoder used in the mastering process has its parameters changed to change the P-subchannel and/or Q-subchannel data.

Additionally and/or alternatively, the encoder used in the mastering process has its parameters changed to change navigation and/or timing data of the mastered disc.

The present invention also extends to a copy protected digital audio compact disc, wherein control data is encoded on the compact disc, and wherein selected control data has been rendered incorrect and/or inaccurate, the incorrect and/or inaccurate control data being arranged to interfere with the reading of audio data from the digital audio compact disc.

Generally, the incorrect and/or inaccurate control data is arranged such that it cannot be corrected by the error correction arrangements of available data readers.

In a preferred embodiment of a copy protected digital audio compact disc of the present invention, navigation and/or timing data encoded on the compact disc has been rendered incorrect and/or inaccurate.

In an embodiment of a copy protected digital audio compact disc of the present invention, P-subchannel data and/or Q-subchannel data encoded on the compact disc has been rendered incorrect and/or inaccurate.

Preferably, in a preferred embodiment of a copy protected digital audio compact disc of the invention, navigation and/or timing data from the P-subchannel and/or from the Q-subchannel is modified.

In an embodiment, P-subchannel data encoded on the disc which identifies the start and length of audio tracks is modified.

Additionally and/or alternatively, Q-subchannel data defining the Ttime of audio tracks on the disc is modified.

For example, the Ttime data is modified to change the profile of the Ttime along the related audio track. The profile of the modified Ttime may be stepped, discontinuous, modulated or otherwise altered.

Additionally and/or alternatively, Q-subchannel data defining the Atime across the disc is modified.

For example, the Atime is modified to change the profile of the Atime across the disc. The profile of the modified Atime may be stepped, discontinuous, modulated or otherwise altered.

A copy protected digital audio compact disc of the invention may have any one or combination of the modifications described above either alone or in combination with other control data which is incorrect and/or inaccurate.

Embodiments of the present invention will hereinafter be described, by way of example, with reference to the accompanying drawings, in which:

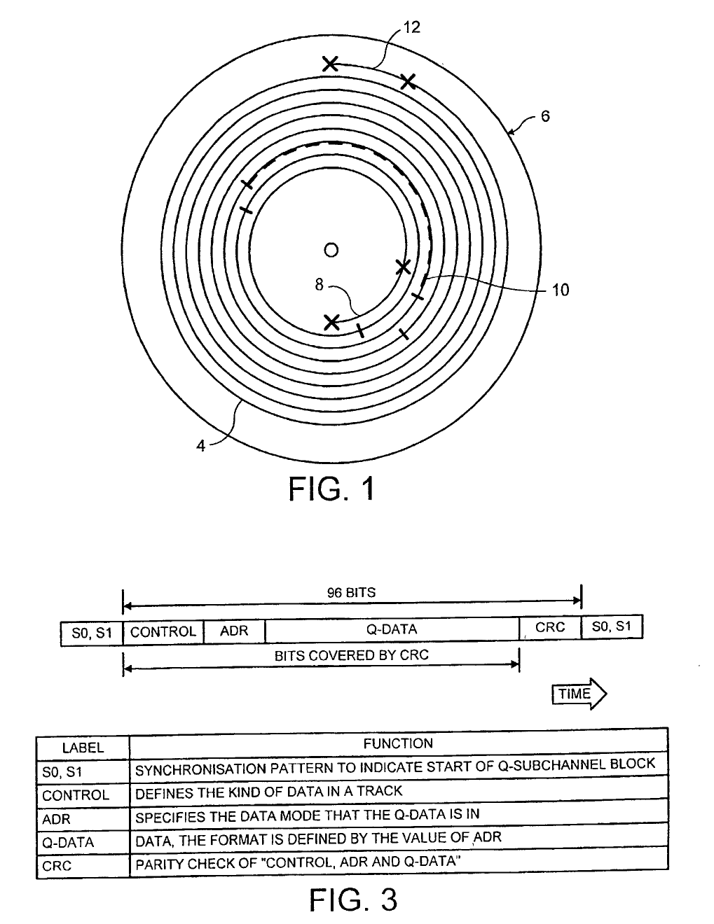

FIG. 1 shows schematically a compact disc showing the spiral data track,

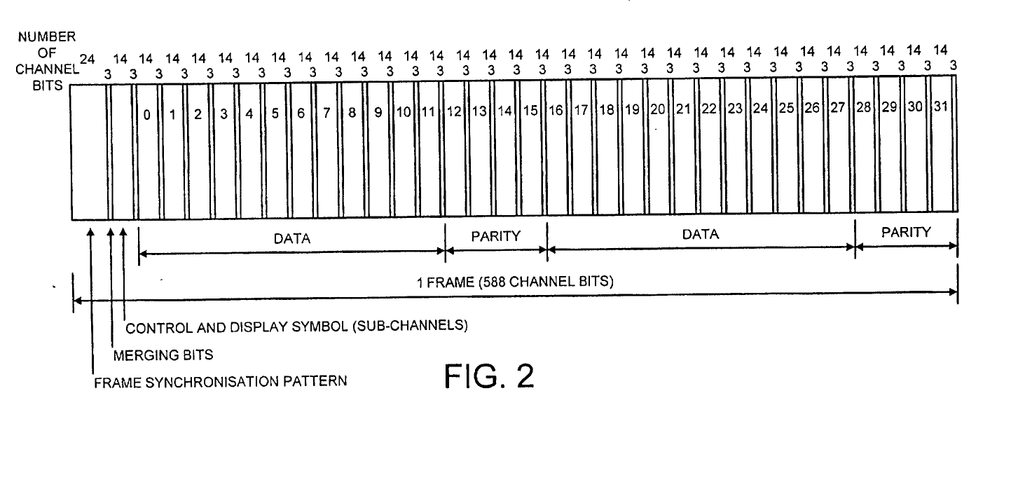

FIG. 2 shows the structure of a frame of data encoded on a CD,

FIG. 3 illustrates the general data format of the Q-subchannel,

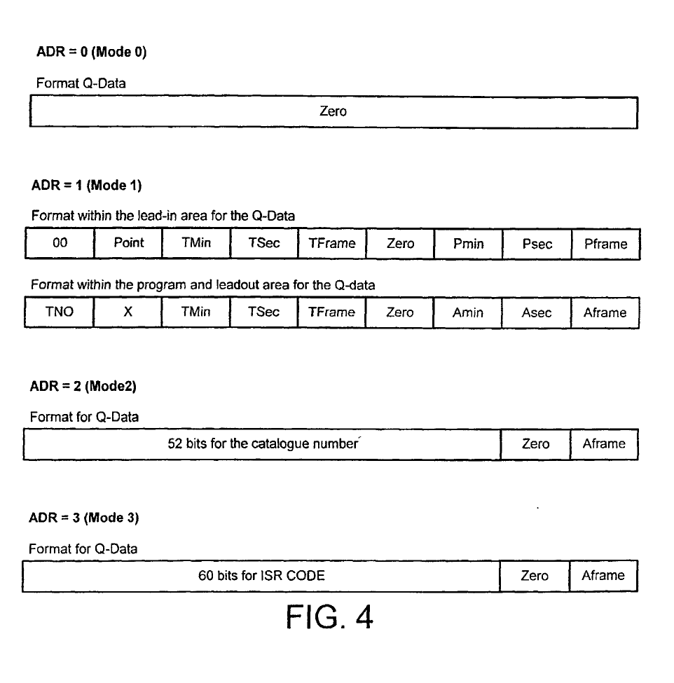

FIG. 4 shows the format of the data for the Q-subchannel according to mode,

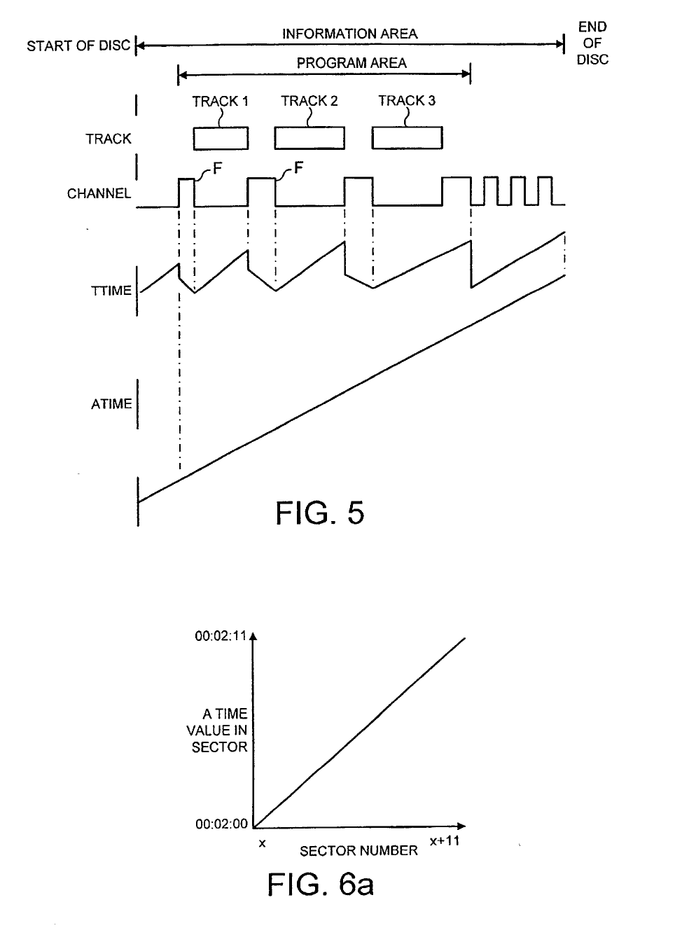

FIG. 5 shows graphically both Atime and Ttime on a compact disc,

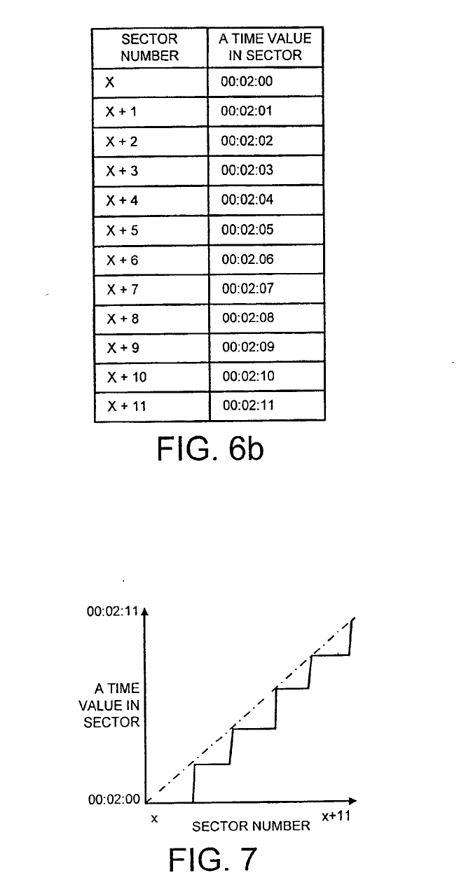

FIG. 6a shows graphically a segment of Atime, and FIG. 6b gives the time/sector relationship of the graph of FIG. 6a,

FIG. 7 shows modification of Atime by stepping,

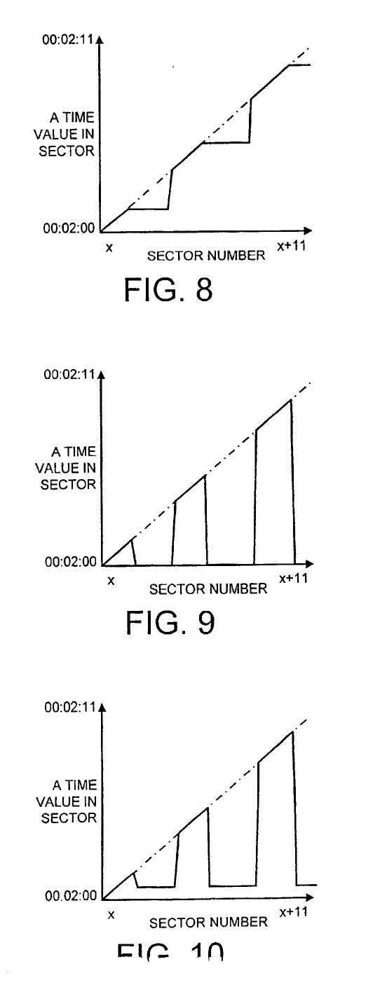

FIG. 8 shows modification of Atime by modulation,

FIG. 9 shows modification of Atime by setting Mode 0 such that Atime is zeroed,

FIG. 10 shows modification of Atime by the use of an invalid CRC,

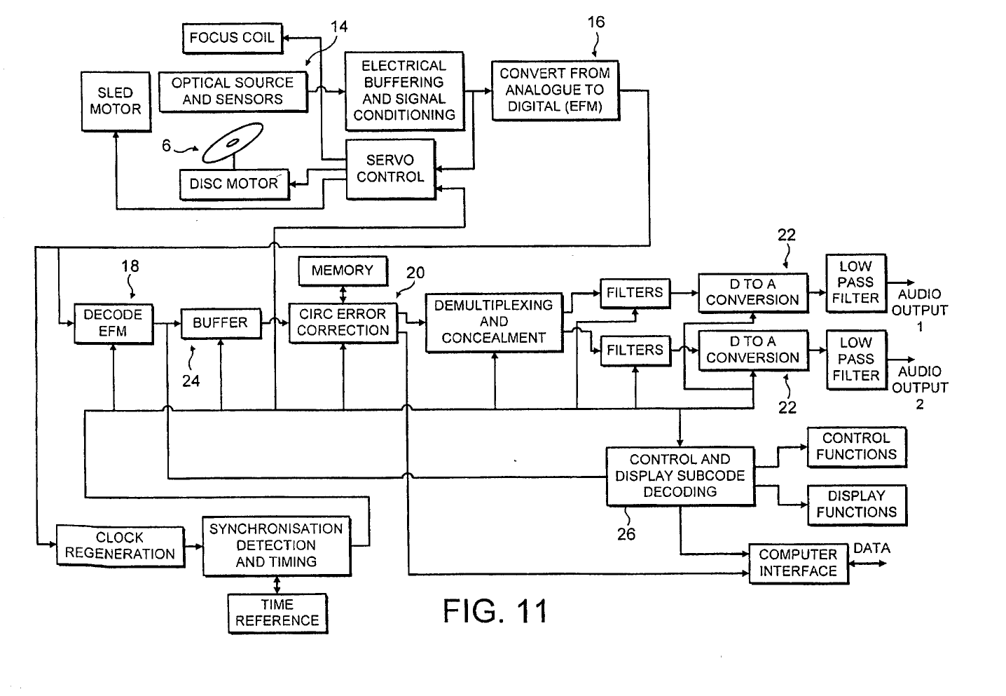

FIG. 11 shows a block diagram of a data reader,

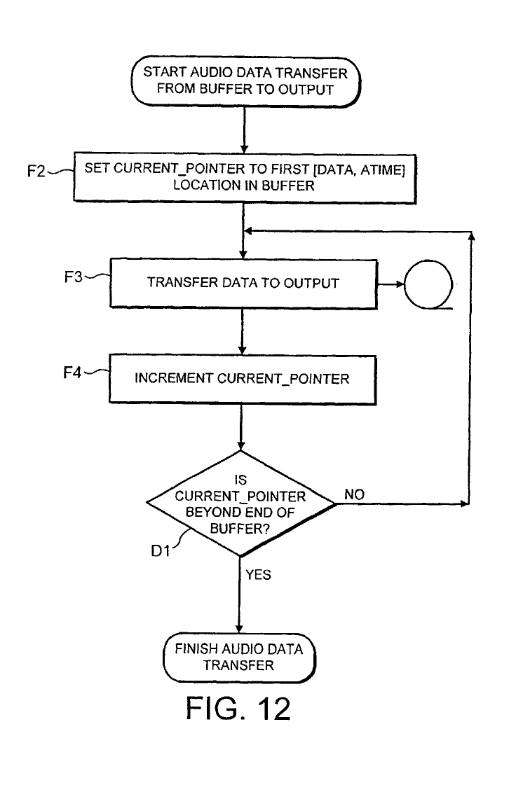

FIG. 12 is a flow diagram showing the routine of an audio player for outputting audio data from a CD, and

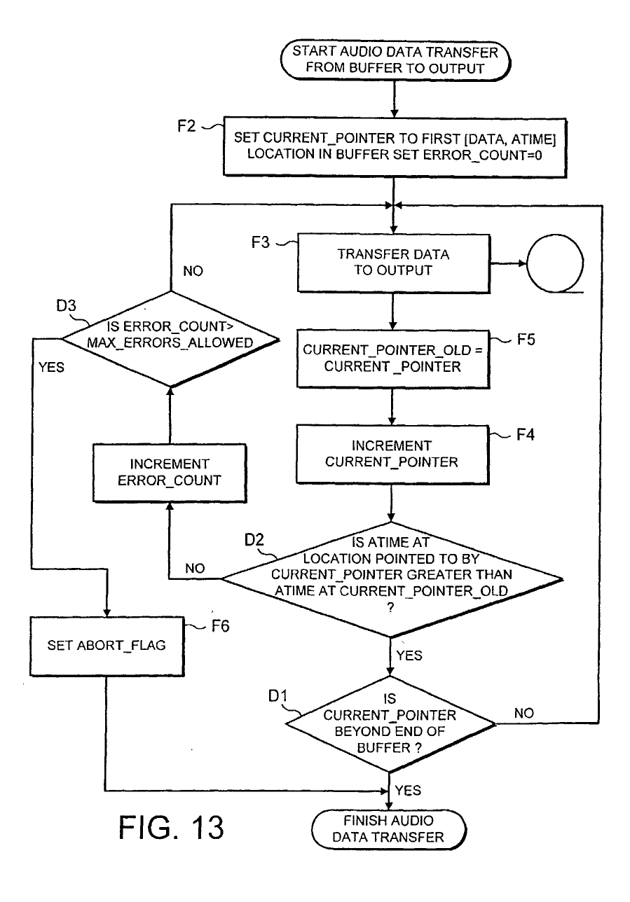

FIG. 13 is a flow diagram showing a routine of a data reader for outputting audio data from a CD.

A digital audio compact disc (CD-DA), which carries music and is to be played on an audio player such as a conventional CD disc player, is made and recorded to a standard format known as the Red Book standards. As well as defining physical properties of the disc, such as its dimensions, and its optical properties, such as the laser wavelength, the Red Book also defines the signal format and the data encoding to be used.

As is well known, the use of the Red Book standards ensure that any CD-DA produced to those standards will play on any audio player produced to those standards.

FIG. 1 shows schematically the spiral track 4 on a CD 6. This spiral track 4 on a CD-DA is divided into a Lead-In 8, a number of successive music or audio tracks as 10, and a Lead-Out 12. The Lead-In track 8 includes a Table of Contents (TOC) which identifies for the player the tracks to follow, whilst the Lead-Out 12 gives notice that the spiral track 4 is to end.

An audio player always accesses the Lead-In track 8 on start up. The music tracks may then be played consecutively as the read head follows the track 4 from Lead-In to Lead-Out. Alternatively, the player navigates the read head to the beginning of each audio track 10 as required.

To the naked eye, a CD-ROM looks exactly the same as a CD-DA and has the same spiral track 4 divided into sectors. However, data readers, such as CD-ROM drives, are much more sophisticated and are enabled to read data, and process information, from each sector of the compact disc according to the nature of that data or information. A data reader can navigate by reading information from each sector whereby the read head can be driven to access any appropriate part of the spiral track 4 as required.

To ensure that any data reader can read any CD-ROM, the compact discs and readers are also made to standards known, in this case, as the Yellow Book standards. These Yellow Book standards incorporate, but extend, the Red Book standards. Hence, a data reader, such as a CD-ROM drive, can be controlled to play a CD-DA.

The ability of a data reader to access, extract, or otherwise read the data on a CD-DA provides a problem for the music industry. A user can use his CD-ROM drive to read the data from an audio disc, for example, into a computer file, and then that data can be copied. The increasing availability of recorders able to record onto compact discs means that individuals and organisations now have easy access to technology for making perfect copies of audio compact discs. This is of great concern to the music industry.

An audio player, be it a dedicated compact disc music player, or a more sophisticated CD-ROM drive when controlled to play an audio disc, only looks for and uses data encoded to Red Book standards. What is more, if there appears to be an inaccuracy in the data, an audio player will generally continue to play rather than trying to correct the error. For example, if the read head has navigated to the start of a track and commenced to play that track, the audio player will continue to play that track to its end, even if it becomes apparent that there is some error in the timing information, for example. By contrast, a data reader is arranged to identify and correct errors. The present invention therefore suggests that errors should be deliberately introduced into the Red Book data, but that these errors should be of a type which are generally transparent to an audio player but which will interfere with the extraction or reading of the audio data by a data reader. By this means, the data reader is either unable to read the audio disc, and/or produces copies with degraded sound.

As the data encoding on a CD-DA and on a CD-ROM is well known and in accordance with the appropriate standards, it is not necessary to describe it in detail herein.

Briefly, the data on a CD is encoded into frames by EFM (eight to fourteen modulation). FIG. 2 shows the format of a frame, and as is apparent therefrom, each frame has sync data, sub-code bits providing control and display symbols, data bits and parity bits. Each frame includes 24 bytes of data, which, for a CD-DA, is audio data.

There are 8 subcode bits contained in every frame and designated as P, Q, R, S, T, U, V and W. Generally only the P and Q sub-code bits are used in the audio format. The standard requires that 98 of the frames of FIG. 2 are grouped into a sector, and the sub-code bits from the 98 frames are collected to form sub-code blocks. That is, each sub-code block is constructed a byte at a time from 98 successive frames. In this way, 8 different subchannels, P to W, are formed. These subchannels contain control data for the disc. The P- and Q- subchannels incorporate timing and navigation data for the tracks on the disc, and generally are the only subchannels utilised on an audio disc.

The data format for a Q-subchannel block assembled from 98 successive frames is indicated in FIG. 3. As is apparent, the start of the subchannel block is indicated by the appearance of sync patterns S0 and S1 as the first 2 symbols. The next data bits are control bits to define the contents of a track. Thus, the control bits might identify audio content or data content. There then follows address information, ADR, which specifies one of four modes for the Q-data bits. 72 bits of Q-data succeed the address information, and then there are 16 CRC, or check, bits which are used for error detection on the control, address and Q-data bits.

FIG. 4 illustrates the data content of a Q-subchannel block in each of the four modes designated by the address information, ADR. In Mode 0, all of the Q-data has a value of zero. In Mode 0, the data of the P-subchannel is also set to zero. In Mode 2, the Q-data comprises a catalogue number for the disc, such as a bar code of the Universal Product Code. In addition, in Mode 2 the Atime count from adjacent blocks is continued. Mode 3 is used to give ISR code for identifying each music track. In addition, and as is illustrated, in Mode 3 the absolute time count, Atime, is continued.

As indicated in FIG. 4, in Mode 1 the Q-data in each subchannel block contains program and time information for individual audio tracks and for the information area of the disc. As is illustrated, there is a different format for the Q-data for the Lead-In area to that within the program and Lead-Out areas. However, in both formats in Mode 1, the Q-data gives information as to the time along a track. The running time of a track is referred to as the Ttime, is in minutes, seconds and frames, and TMin, TSec and TFrame are all components of Ttime. In the program and Lead-Out areas, the Q-data additionally includes information about the absolute time, Atime, on the disc in minutes, seconds and frames, and Amin, Asec and Aframe are all components of Atime.

FIG. 5 shows graphically how Atime and Ttime vary across a disc. Atime is the absolute time of the information area of the disc and starts at zero at the beginning of that information area. Ttime is the running time within each track and thus starts at zero at the beginning of each track. Thus, and as illustrated in FIG. 5, Atime increases monotonically across the disc whilst Ttime increases along each individual track As is also illustrated in FIG. 5, the P-subchannel includes flags F which each indicate the start of a respective track.

As indicated in FIG. 4, in Mode 1 each Q-subchannel block contains the next consecutive values for Atime and Ttime. When an audio player is to play an audio track, the head is navigated to the commencement of a track. The navigation may be by way of the Atime, the Ttime, and/or the P-subchannel flags, or by some combination thereof. In general, once an audio player has commenced playing a track, it will continue. Playing of the track is not generally stopped if any data errors are located, and thus the audio player effectively ignores any data errors which arise. Thus, if an audio player can be reliably navigated to the commencement of a track, it can be expected to provide a continuous audio output from that track without problem even if timing information along that track has been incorrectly modified.

A data reader, by contrast, is programmed to be able to access the data on a compact disc in a random, rather than in a serial manner, and therefore continually checks the timing and program information. What is more, if there are errors in the data, a data reader will try to correct those errors. Thus, a data reader will not ignore timing errors. The data reader may stop the output of the data as it seeks to correct the errors, for example, by re-reading the data in an attempt to obtain error free data. This could prevent the provision of an audio output, or may cause the data reader to attempt to perform corrections in such a manner that a copy made from the “corrected” data will produce degraded sound.

Clearly there are several ways in which the Ttime, the Atime and/or the P-subchannel can be altered to copy protect an audio disc. However, in general, no alteration is made to bands at the start or the end of each track, or around index points, as this could interfere with the normal navigation of an audio player. So, for example, it may be arranged that there is no incorrect timing or navigation information during the first 5 seconds into each individual audio track.

FIGS. 6a and 6b show graphically the normal form of Atime which, as is clear from FIG. 6a, increases monotonically across the disc. FIG. 6a shows the Atime across a number of consecutive sectors of the disc, and FIG. 6b identifies each of those sectors by a consecutive number and shows the Atime value in each sector. It will be appreciated that Ttime has a similar form to that illustrated for Atime in FIGS. 6a and 6b.

FIG. 7 shows one method by which Atime may be modified to copy protect an audio disc. Thus, instead of the Atime increasing continuously across the disc, the Atime is held at the same value during some of the time of each track so that a stepped pattern as illustrated arises.

In FIG. 8, the Atime has been modulated such that it has steps or discontinuities in the usual straight line graph. In this modification, the modulated Atime follows the gradient of the unmodified Atime at times other than during the discontinuities.

In the embodiment illustrated in FIG. 9, the mode of selected frames has been set to Mode 0 such that after a number of unaltered sectors, the portion of the Q-subchannel block which, in Mode 1, would normally correspond to Atime now contains zeros. The FIG. 9 modulation is therefore similar to that of FIG. 8, except that with FIG. 8 the Atime is held steady across a plurality of sectors, whereas in the scheme of FIG. 9 the Atime is pulled to zero.

FIG. 10 illustrates a further method for modifying the Atime. In the FIG. 10 implementation, the CRC information in the Q-subchannel blocks is invalidated, for example, in a manner to give multiple sectors the same time values. The graph of FIG. 10 is the result of substituting a constant time value for each missing time. The graph shown in FIG. 9 could alternatively have been produced by setting the constant value to zero. Similarly, the graph of FIG. 8 could have been achieved by substituting for the missing time values the last valid time value.

The methods described above may additionally or alternatively be used to modify Ttime.

As explained, once an audio player has located the start point of an audio track, it will play that track from start to end even if it encounters incorrect timing information. In this respect, an audio player generally only monitors data from the Q-subchannel to enable it to display, for example, the time along the track or the number of the track. The audio player, therefore, undertakes a “streaming play” operation.

A data reader requires a much greater depth of information so that it is able to identify and correct, for example, corrupt data. Where a data reader encounters discrepancies in Atime and Ttime it tries to make sense of those discrepancies by way of various error correction routines. If the data reader encounters too many errors it may abort the attempt to output the data content. If the data reader is able to output the data content, this may be with errors “corrected” such that if the resultant data stream is recorded to make a copy, that copy will produce degraded sound.

However, there are some types of data readers which will perform a serial data extraction on audio tracks, and which function much more like an audio player, than like a CD-ROM drive, for example, when they encounter missing or repeated frames in the Q-subchannel. In a similar manner to the operation of an audio player, therefore, the data extraction from such a data reader can continue even if timing errors are encountered, such that the errors do not stop the data extraction or act to corrupt copies.

To provide for copy protection for CD-DAs effective for data readers which are able to ignore timing errors in this way, it is ensured that the number of data frames in a sector which have incorrect data exceeds the number of data frames which can be held in the frame content buffer of that data reader.

FIG. 11 shows schematically a data reader for playing or extracting data from a CD 6. As can be seen, the analogue signal detected by the optical system, generally referenced 14, is converted by converter 16 into digital EFM form. The EFM data is decoded at decoder 18 and is subject to error correction at stage 20. The resulting 24 bytes of data obtained from each frame are split into 4 byte samples and are clocked at a constant rate into a digital to analogue converter 22 to produce the audio output signal. The operation of the circuits is under the control of a controller 26.

The EFM data decoded at decoder 18 is input to a buffer 24 which will generally be either 16K bits or 32K bits of SRAM. This means that the buffer 24 can be filled with decoded data from a number of frames such that the controller 26 is able to scan through data in the buffer 24 and identify demarcation points between sectors. This enables the controller 26 to look for “the next sector which succeeds the one just processed”. However, in simpler data readers, the controller may be programmed to look simply for a sector other than the one just processed and it is this type of routine which enables serial data extraction to continue even if there are timing errors.

FIG. 12 illustrates in a flow diagram a routine used by an audio player to play audio. It will be seen in FIG. 12 that having started the process of transferring audio data from the buffer 24 to the output, the routine of controller 26 looks at function box F2 to set a current pointer to a first location in the buffer. This location holds data and the Atime. The transfer of the data at the first location to the output is commenced by function box F3 whereupon, at function box F4, the value of the current pointer is incremented to access the next location. At subsequent decision box D1 the routine decides whether the new value of the current pointer is beyond the end of the buffer. If it is not, the routine repeats. It will be appreciated that the repeating routine thereby accesses the data at each location in the buffer, which is thereby transferred to the output. The transfer of the data to the output is in series and stops when all locations of the buffer have been accessed. The routine is not dependent upon the value of Atime and thus any errors in Atime do not stop the transfer of data to the output.

FIG. 13 illustrates in a flow diagram a routine in which a data reader, when seeking to transfer data to the output, additionally performs checks to ensure that the Atime is correct. Thus, at function box F2 not only is the value of a current pointer set, but an error count is set to zero. The routine continues through function boxes F3 and F4 by way of an additional function box F5 which retrieves the value of the last current pointer before incrementing the current pointer. At decision box D2, therefore, it is possible to compare the Atime value for the current pointer with the Atime value of the immediately preceding current pointer. If the value of the current Atime is not greater than the immediately preceding value, the error count is increased. A decision box D3 determines if the errors exceed the maximum allowed and if they do, an abort flag F6 is set whereby the transfer of data to the output is suspended.

It will be appreciated that a data reader, operating according to a routine as in FIG. 13 and finding that the Atime does not increment within the buffer more times than set by the decision box D3, will abort the transfer of data to the output. In these circumstances, the data reader may be controlled to stop data extract completely. Alternatively, the controller 26 may handle the abort flag by preventing the transfer of blocks of data, or by adding “corrections”. All of these measures are likely to provide degradation of the sound to be produced from the data.

It will be appreciated that modifications to and variations in the techniques described above may be made within the scope of this application.

1. A method of copy protecting a digital audio compact disc, wherein control data is encoded on the compact disc, the copy protection method comprising the step of rendering selected control data incorrect and/or inaccurate whereby the incorrect and/or inaccurate control data interferes with the reading of audio data from the digital audio compact disc.

2. A copy protection method as claimed in claim 1, wherein the incorrect and/or inaccurate control data is arranged such that it cannot be corrected by the error correction arrangements of available data readers.

3. A copy protection method as claimed in claim 1 or claim 2, wherein the incorrect data encoded onto the compact disc is arranged either to be ignored or otherwise not to generally have an effect on the playing of the audio data on the disc.

4. A copy protection method as claimed in any preceding claim, wherein the data encoded on the compact disc which has been rendered incorrect is navigation and/or timing data.

5. A copy protection method as claimed in claim 4, wherein the data encoded on the compact disc which has been rendered incorrect is P-subchannel or Q-subchannel data.

6. A copy protection method as claimed in claim 5, wherein navigation and/or timing data from the P-subchannnel and/or from the Q-subchannel is modified.

7. A copy protection method as claimed in any of claims 4 to 6, wherein P-subchannel data, identifying the start and length of audio tracks on the disc, is modified.

8. A copy protection method as claimed in any of claims 4 to 7, wherein Q-subchannel data defining the Ttime of audio tracks on the disc is modified.

9. A copy protection method as claimed in claim 8, wherein the Ttime of individual audio tracks is modified to change the profile of the Ttime along the corresponding audio track.

10. A copy protection method as claimed in claim 9, wherein the profile of the modified Ttime is stepped, discontinuous, modulated or otherwise altered.

11. A copy protection method as claimed in any of claims 4 to 10, wherein Q-subchannel data defining the Atime across the disc is modified.

12. A copy protection method as claimed in claim 11, wherein the Atime is modified to change the profile of the Atime across the disc.

13. A copy protection method as claimed in claim 12, wherein the profile of the modified Atime is stepped, discontinuous, modulated or otherwise altered.

14. A copy protection method as claimed in any of claims 4 to 13, wherein other control data is incorrect and/or inaccurate.

15. A copy protection method as claimed in any preceding claim, for use where frames of control data are read into a frame content buffer of a data reader, wherein the number of data frames in a sector with incorrect control data is arranged to exceed the number of data frames which can be held in the frame content buffer.

16. A copy protection method as claimed in any preceding claim, wherein the control data encoded on the compact disc is altered prior to mastering of the disc.

17. A copy protection method as claimed in claim 16, wherein the parameters of an encoder used in the mastering process are changed to change the P-subchannel and/or Q-subchannel data.

18. A copy protection method as claimed in claim 16 or claim 17, wherein the parameters of an encoder used in the mastering process are changed to change navigation and/or timing data of the mastered disc.

19. A copy protected digital audio compact disc, wherein control data is encoded on the compact disc, and wherein selected control data has been rendered incorrect and/or inaccurate, the incorrect and/or inaccurate control data being arranged to interfere with the reading of audio data from the digital audio compact disc.

20. A copy protected digital audio compact disc as claimed in claim 19, wherein the incorrect and/or inaccurate control data is arranged such that it cannot be corrected by the error correction arrangements of available data readers.

21. A copy protected digital audio compact disc as claimed in claim 19 or claim 20, wherein navigation and/or timing data encoded on the compact disc has been rendered incorrect and/or inaccurate.

22. A copy protected digital audio compact disc as claimed in any of claims 19 to 21, wherein P-subchannel data and/or Q-subchannel data encoded on the compact disc has been rendered incorrect and/or inaccurate.

23. A copy protected digital audio compact disc as claimed in claim 22, wherein navigation and/or timing data from the P-subchannel and/or from the Q-subchannel is modified.

24. A copy protected digital audio compact disc as claimed in claim 22 or claim 23, wherein P-subchannel data encoded on the disc which identifies the start and length of audio tracks is modified.

25. A copy protected digital audio compact disc as claimed in any of claims 22 to 24, wherein Q-subchannel data defining the Ttime of audio tracks on the disc is modified.

26. A copy protected digital audio compact disc as claimed in claim 25, wherein the Ttime data is modified to change the profile of the Ttime along the related audio track.

27. A copy protected digital audio compact disc as claimed as claimed in claim 26, wherein the profile of the modified Ttime is stepped, discontinuous, modulated or otherwise altered.

28. A copy protected digital audio compact disc as claimed in any of claims 22 to 27, wherein Q-subchannel data defining the Atime across the disc is modified.

29. A copy protected digital audio compact disc as claimed in claim 28, wherein the Atime is modified to change the profile of the Atime across the disc.

30. A copy protected digital audio compact disc as claimed in claim 29, wherein the profile of the modified Atime is stepped, discontinuous, modulated or otherwise altered.

31. A method of copy protecting a digital audio compact disc substantially as hereinbefore described with reference to the accompanying drawings.

32. A copy protected digital audio compact disc substantially as hereinbefore described with reference to the accompanying drawings.
